(19) United States
(12) Patent Application Publication
(10) Pub. No.: US 2008/0208981 A1
(43) Pub. Date: Aug. 28, 2008

(54) Providing Information Regarding Mailing List Aliases

(76) Inventors: Itzhack Goldberg, Hadera (IL); Yotam Medini, Binyamina (IL); Boaz Mizrachi, Haifa (IL); Kenneth Nagin, Hamovil (IL)

Correspondence Address: LOTUS AND RATIONAL SOFTWARE;David A. Dagg, Esq., 44 Chapin Road, Newton, MA, 02459, US

(21) Appl. No.: 11/680,126

(22) Filed: Feb. 28, 2007

(51) Int. Cl. G06F 15/16

(52) U.S. Cl. 709/206

(57) ABSTRACT

A method for providing information regarding mailing list aliases, the method including displaying an email message including at least one mailing list alias, and displaying an email address of a recipient of the email message in association with the mailing list alias.

### FIELD OF THE INVENTION

The present invention relates to electronic mail systems in general, and in particular to providing information regarding mailing list aliases.

### BACKGROUND OF THE INVENTION

Mailing list aliases are often used in electronic mail (email) systems to allow an email message to be sent to be multiple recipients without having to individually specify the email address of each recipient. Thus, as shown by way of example in FIG. 1, an email message 100 may be sent from a computer 102 to a email server 104 and then on to a recipient computer 106 via a network 108, such as the Internet. Rather than inserting the individual email address of each intended recipient of email message 100, the recipients of email message 100 are indicated using the mailing list aliases “SPORTS-LIST” and “BUDDIES” which are mapped to one or more individual email addresses in a mapping 110. Thus, the email address “BOB@FGH.COM” is shown in mapping 110 as belonging to both the “SPORTS-LIST” and “BUDDIES” aliases, while “PHIL SURT.ORG” belongs only to the “SPORTS-LIST” alias. When email message 100 is sent, server 104 uses mapping 110 to determine which email addresses are mapped to each mailing list alias indicated in email message 100 and sends email message 100 to the appropriate email addresses.

Typically, recipients of email messages that are sent using mailing list aliases see the mailing list aliases used, but not their underlying email addresses. However, a recipient may wish to know to which mailing list aliases his/her email address belongs. With this information, the recipient may recommend to the manager of the mailing list the addition of other colleagues to the alias, may ask to be removed from an alias, or may take steps to prevent receiving multiple copies of an email that is sent to multiple mailing lists where the recipient belongs to more than one of the lists.

### SUMMARY OF EMBODIMENTS OF THE INVENTION

The present invention in embodiments thereof discloses systems and methods for providing information regarding mailing list aliases to recipients of email messages that are sent using mailing list aliases.

In accordance with a first aspect of the present invention a method for providing information regarding mailing list aliases is provided, the method includes displaying an email message including at least one mailing list alias, and displaying an email address of a recipient of the email message in association with the mailing list alias.

In accordance with a second aspect of the present invention a method for providing information regarding mailing list aliases is provided, the method includes displaying an email message including at least one mailing list alias, and displaying the mailing list alias in a predefined manner that indicates that said mailing list alias is mapped to an email address of a recipient of the email message.

In accordance with a third aspect of the present invention a system for providing information regarding mailing list aliases is provided, the system includes an alias detector configured to detect at least one mailing list alias in an email message received by a recipient, an alias display controller configured to display an email address of a recipient of said email message in association with said mailing list alias.

In accordance with a fourth aspect of the present invention a computer program embodied on a computer-readable medium is provided, the computer program includes a first code segment operative to display an email message including at least one mailing list alias, and a second code segment operative to display an email address of a recipient of the email message in association with said mailing list alias.

### BRIEF DESCRIPTION OF THE DRAWINGS

Embodiments of the present invention will be understood and appreciated more fully from the following detailed description taken in conjunction with the appended drawings in which:

FIG. 1 is a simplified conceptual illustration of a prior art electronic mail system employing mailing list aliases; and

FIGS. 2-4 are simplified conceptual illustrations of alternative electronic mail systems employing mailing list aliases, constructed and operative in accordance with an embodiment of the present invention.

### DETAILED DESCRIPTION OF EMBODIMENTS OF THE INVENTION

The present invention is now described within the context of one or more embodiments, although the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

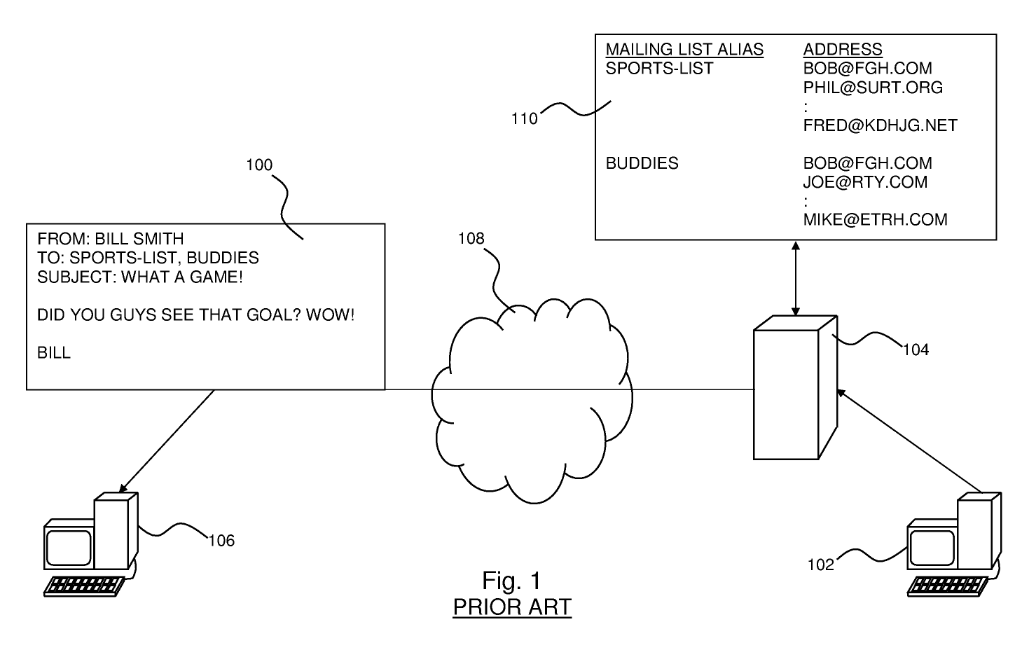

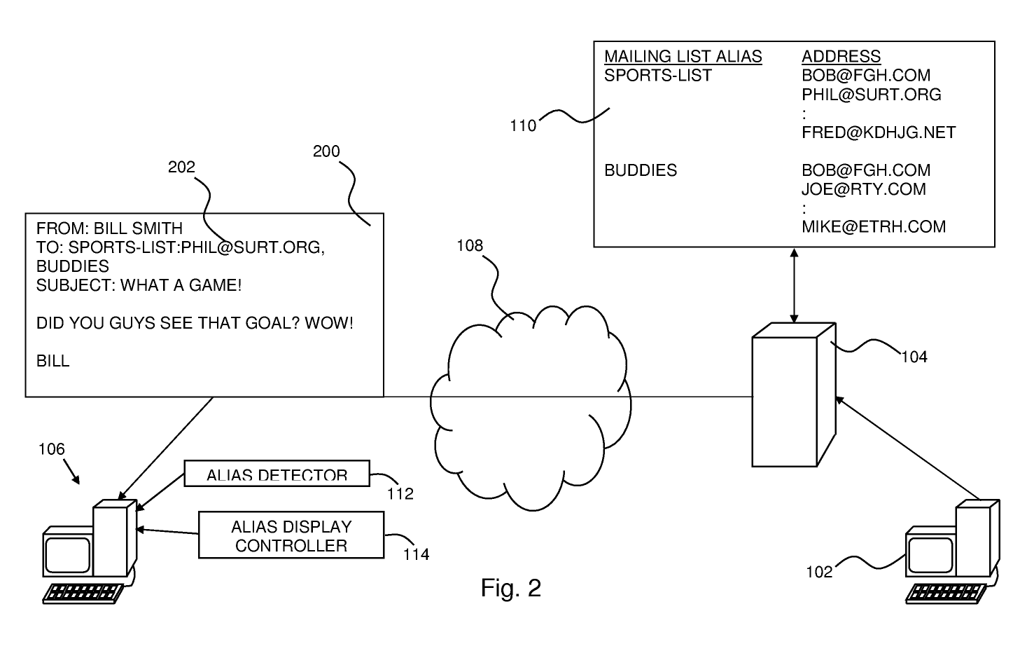

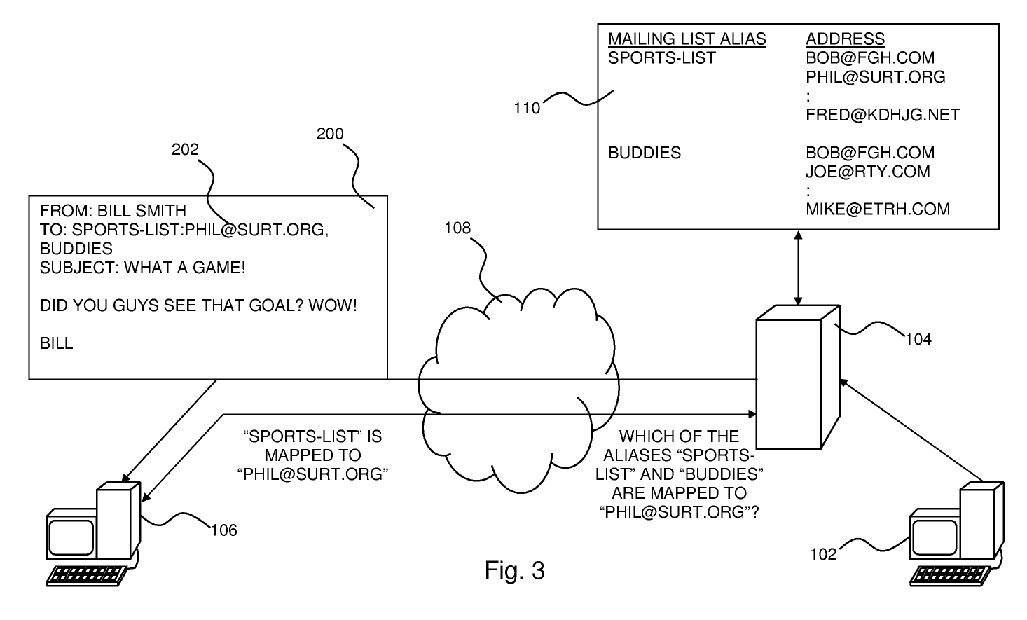

Reference is now made to FIG. 2, which is a simplified conceptual illustration of an electronic mail system employing mailing list aliases, constructed and operative in accordance with an embodiment of the present invention. The system of FIG. 2 is substantially similar to the system of FIG. 1 with the notable exception that instead of email message 100 showing just the mailing list aliases, an email message 200 is shown in which an email address 202 of the recipient of email message 200 is displayed in association with the mailing list alias to which email address 202 is mapped in mapping 110. Thus, in the example shown, the email address “PHIL@SURT.ORG” of the recipient of email message 200 is displayed together with the mailing list alias “SPORTS-LIST” to which the email address is mapped, with the two being concatenated using a colon, although any method for displaying two items of text in association with each other may be used. The recipient's email address and its association with a mailing list alias may be received as part of email message 200, such as within the message header, with the recipient's email address and its association with a mailing list alias being detected by an alias detector 112 configured with computer 106. Alternatively, as shown in FIG. 3, alias detector 112 may request and receive from server 104 or computer 102 an indication as to which mailing list alias is associated with the recipient's email address. An alias display controller 114 that is configured with computer 106 displays the recipient's email address in association with the mailing list alias to which it is mapped. Alias detector 112 may request and receive this information upon detecting multiple mailing list aliases as a destination of email message 200, or at the request of the recipient, such as where the recipient presses a button designated for this purpose. It is appreciated that any actions described herein that are taken by computer 106, alias detector 112, and alias display controller 114 may be performed by email software installed on computer 106 and configured to perform such actions.

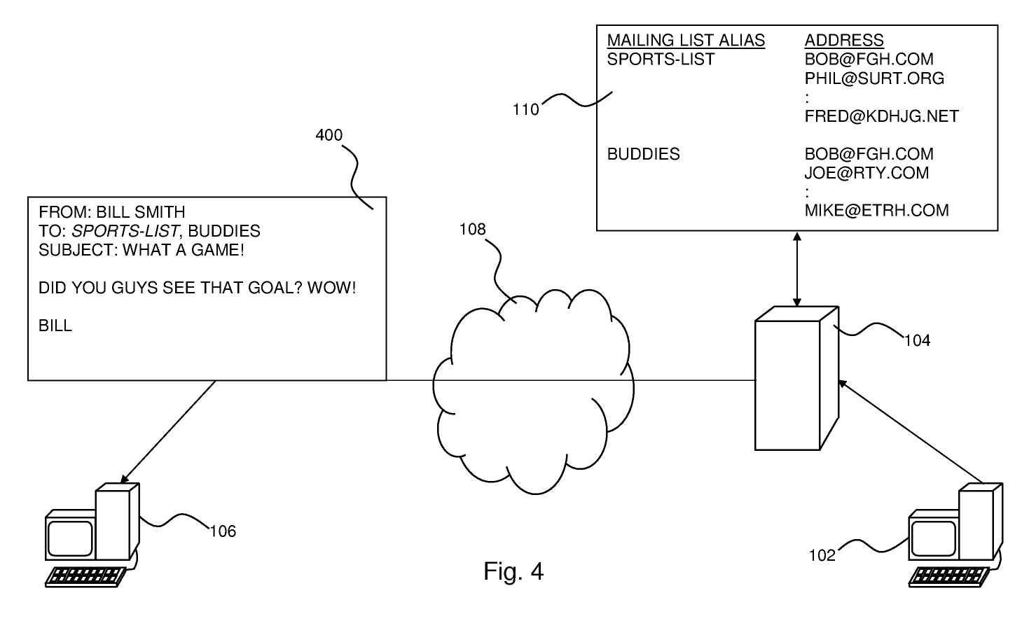

Reference is now made to FIG. 4, which is a simplified conceptual illustration of an electronic mail system employing mailing list aliases, constructed and operative in accordance with an embodiment of the present invention. The system of FIG. 4 is substantially similar to the systems of FIGS. 2 and 3 with the notable exception that instead of displaying the email address of the recipient of an email message 400 in association with a mailing list alias to which the email address of the recipient is mapped, alias display controller 114 displays the mailing list alias in a predefined manner that indicates that it is mapped to the recipient's email address. This indication may include displaying the mailing list alias in a bold, underlined, and/or italicized typeface, or any other type of indication, while other mailing list aliases that are not mapped to the recipient's email address are displayed without such indications. Thus, in the example shown in FIG. 4, the mailing list alias “SPORTS-LIST” to which the recipient “PHIL SURT.ORG” belongs is displayed in italics, while the mailing list alias “BUDDIES” to which the recipient does not belong is not italicized.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

What is claimed is:

1. A method for providing information regarding mailing list aliases, the method comprising:
displaying an email message including at least one mailing list alias; and
displaying an email address of a recipient of said email message in association with said mailing list alias.

2. The method according to claim 1 wherein said displaying said email address comprises displaying if said email address is mapped to said mailing list alias.

3. The method according to claim 1 wherein said displaying said email address comprises displaying said email address in propinquity to said mailing list alias.

4. The method according to claim 1 and further comprising:
receiving said email message including a plurality of said mailing list aliases; and
requesting an indication as to which of said mailing list alias is associated with said recipient's email address.

5. The method according to claim 4 wherein said requesting comprises requesting upon detecting said multiple mailing list aliases as a destination of said email message.

6. The method according to claim 4 wherein said requesting comprises requesting upon detecting the pressing of a button designated to trigger said request.

7. A method for providing information regarding mailing list aliases, the method comprising:
displaying an email message including at least one mailing list alias; and
displaying said mailing list alias in a predefined manner that indicates that said mailing list alias is mapped to an email address of a recipient of said email message.

8. The method according to claim 7 wherein said displaying said mailing list alias in said predefined manner comprises displaying if said email address is mapped to said mailing list alias.

9. The method according to claim 7 and further comprising:
receiving said email message including a plurality of said mailing list aliases; and
requesting an indication as to which of said mailing list alias is associated with said recipient's email address.

10. The method according to claim 9 wherein said requesting comprises requesting upon detecting said multiple mailing list aliases as a destination of said email message.

11. The method according to claim 9 wherein said requesting comprises requesting upon detecting the pressing of a button designated to trigger said request.

12. A system for providing information regarding mailing list aliases, the system comprising:
an alias detector configured to detect at least one mailing list alias in an email message received by a recipient; and
an alias display controller configured to display an email address of a recipient of said email message in association with said mailing list alias.

13. The system according to claim 12 wherein said alias display controller is configured to display said email address if said email address is mapped to said mailing list alias.

14. The system according to claim 12 wherein said alias display controller is configured to display said email address in propinquity to said mailing list alias.

15. The system according to claim 12 wherein said alias detector is configured to request an indication as to which of said mailing list alias is associated with said recipient's email address.

16. The system according to claim 15 wherein said alias detector is configured to make said request upon detecting said multiple mailing list aliases as a destination of said email message.

17. The system according to claim 15 wherein said alias detector is configured to make said request upon detecting the pressing of a button designated to trigger said request.

18. A computer program embodied on a computer-readable storage medium, the computer program comprising:
a first code segment operative to display an email message including at least one mailing list alias; and
a second code segment operative to display an email address of a recipient of said email message in association with said mailing list alias.
